(19) United States
(12) Patent Application Publication
(10) Pub. No.: US 2026/0307407 A1
(43) Pub. Date: Oct. 8, 2026

(54) PRINTER

(71) Applicant: ETRIA Co., Ltd., Kanagawa (JP)

(72) Inventor: Toshiaki Oshiro, Izu Shizuoka (JP)

(21) Appl. No.: 19/447,107

(22) Filed: Jan. 13, 2026

(30) Foreign Application Priority Data
Apr. 4, 2025 (JP) 2025-062219

(51) Int. Cl. B41J 15/04; B41J 3/407; B41J 29/08

(52) U.S. Cl. CPC B41J 15/042; B41J 3/4075; B41J 29/08

(57) ABSTRACT

A printer includes a storage unit configured to store a roll paper; a feeding unit configured to draw out and feed a paper sheet from an outer periphery of the stored roll paper; a printing unit configured to perform printing on the fed paper sheet; and a supporting unit disposed in the storage unit, and configured to rotatably support the stored roll paper and mitigate a drop impact from the roll paper.

### CROSS-REFERENCE TO RELATED APPLICATIONS

The present application claims priority under 35 U.S.C. § 119 to Japanese Patent Application No. 2025-062219, filed on Apr. 4, 2025. The contents of which are incorporated herein by reference in their entirety.

### BACKGROUND

### Technical Field

Embodiments described herein relates to a printer.

### Related Art

Conventionally, a mobile printer such as a portable printer (hereinafter, referred to as a “printer”) can be set up at an optional position for use. Also, a user can wear such a printer at the waist for use, for example.

At the time of printer setup or a user's putting on such a printer or during a user's wearing it, the user may accidentally drop the printer on the floor, a desk, or the ground. In this regard, the printer includes an impact mitigation mechanism in preparation for such a drop. For example, the casing of the printer is deformed at the time of falling, the casing is provided with elastomers on the four sides, or the casing has a rubber-like impact cushioning material attached to the exterior.

Such a printer stores a roll paper formed by winding up an elongated sheet for use as a printing medium. The roll paper is a relatively heavy object, particularly, if it has a large diameter. Hence, the printer containing such a roll paper may receive a significant impact from the roll paper at the time when it is dropped, which may adversely affect other built-in units or elements in the printer (for example, casing, circuit board, display, printing unit, and detachment mechanism).

### BRIEF DESCRIPTION OF THE DRAWINGS

FIG. 1 is an external perspective view of a printer in a state with its cover opened according to an embodiment;

FIG. 2 is a side cross-sectional view illustrating an internal configuration of the printer being in a transverse-placed state;

FIG. 3 is a side cross-sectional view illustrating an internal configuration of the printer being in an upright state;

FIG. 4 is an explanatory diagram illustrating a configuration of supporting units attached to the printer;

FIG. 5 is an explanatory diagram illustrating a detailed configuration of a supporting unit;

FIG. 6 is an enlarged view of the configuration of a supporting unit in the printer being in the upright state;

FIG. 7 is an enlarged view of the configuration of a supporting unit at the time when the printer in the upright state falls and is subjected to an impact;

FIG. 8 is an enlarged view of the configuration of another supporting unit in the printer being in the transverse-placed state;

FIG. 9 is an enlarged view of the configuration of another supporting unit at the time when the printer in the transverse-placed state falls and is subjected to an impact;

FIG. 10 is a side cross-sectional view illustrating the inside of the printer when having fallen in the transverse-placed state and received an impact;

FIG. 11 is a side cross-sectional view of the inside of the printer when having fallen in the upright state and received an impact;

FIG. 12 is an explanatory diagram illustrating a state of the printer with supporting units attached, according to a modification;

FIG. 13 is a side view of a configuration of supporting units when viewed from a lateral side, according to a modification;

FIG. 14 is an explanatory diagram illustrating a configuration of a supporting unit according to a modification; and

FIG. 15 is an explanatory diagram illustrating a configuration of another supporting unit according to a modification.

### DETAILED DESCRIPTION

According to an embodiment, for example, a printer includes a storage unit configured to store a roll paper; a feeding unit configured to draw out and feed a paper sheet from an outer periphery of the stored roll paper; a printing unit configured to perform printing on the fed paper sheet; and a supporting unit disposed in the storage unit and configured to rotatably support the stored roll paper, and mitigate a drop impact from the roll paper.

An embodiment may provide a printer that is able to mitigate the impact from the roll paper when the printer falls.

A printer according to some embodiments will be described in detail below with reference to the accompanying drawings. However, the following embodiments are not to be construed as limiting.

The printer according to an embodiment is, for example, an easy-to-carry, portable printer. Such a printer is installed substantially horizontally (transverse placed) at an optional location. Such a printer is also attachable to a user at the waist in a substantially vertical state, i.e., an upright state, for example. The upright state refers to a state of the printer when rotated from a transverse-placed state by an angle of 90° to stand upright with a storage unit placed at the bottom. To allow a user to put on the printer, the printer is attached to a belt or by fastening a hook, for example. While the user is wearing the printer, the printer is in the upright state.

A roll paper is formed by, for example, winding a paper mount having labels attached thereto at regular intervals along the length or by winding elongated thermal paper (for example, a roll of receipt paper). A printer containing a roll paper having labels attached is, for example, used to print price tags for products in a store or a shop such as a supermarket, a convenience store, or a retail outlet. A printer containing a roll paper having a roll of receipt paper wound is, for example, used to print redelivery information as to a delivery service or to print meter reading information on electricity, gas, or water. In addition, such printers are used to perform printing for a user's task.

Such a printer stores the roll paper in a so-called throw-in method. The throw-in method refers to a method of rotatably holding the outer periphery of the roll paper inside the printer. That is, the printer includes no shaft for pivotally supporting the center of the roll paper.

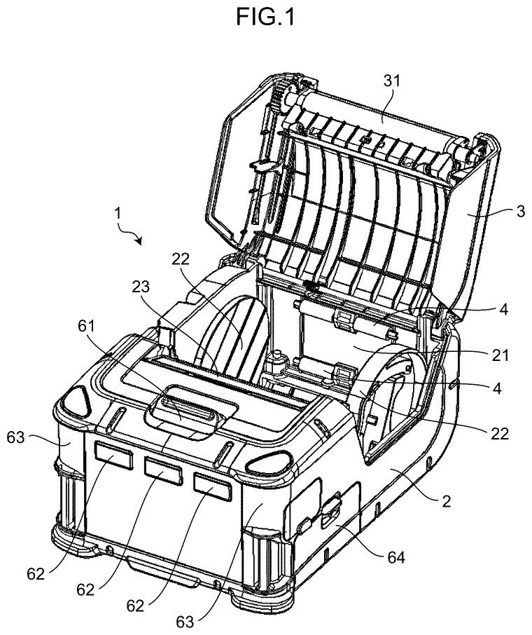

FIG. 1 is an external perspective view of a printer with its cover opened, according to an embodiment. As illustrated in FIG. 1, a printer 1 includes a printer body 2 and a cover 3. The printer body 2 represents a housing (casing) containing the major elements of the printer 1.

The printer body 2 incorporates a power supply unit, a circuit board, and a printing unit. The printer body 2 further includes a storage unit 21 for storing a roll paper. The storage unit 21 is a space inside the printer body 2 and has a width and depth sufficient to store an unused roll paper. Partitions 22 are disposed on both sides of the storage unit 21 to serve as guiding plates for ensuring stable rotation of the roll paper while restricting the widthwise movement of the roll paper stored in the storage unit 21.

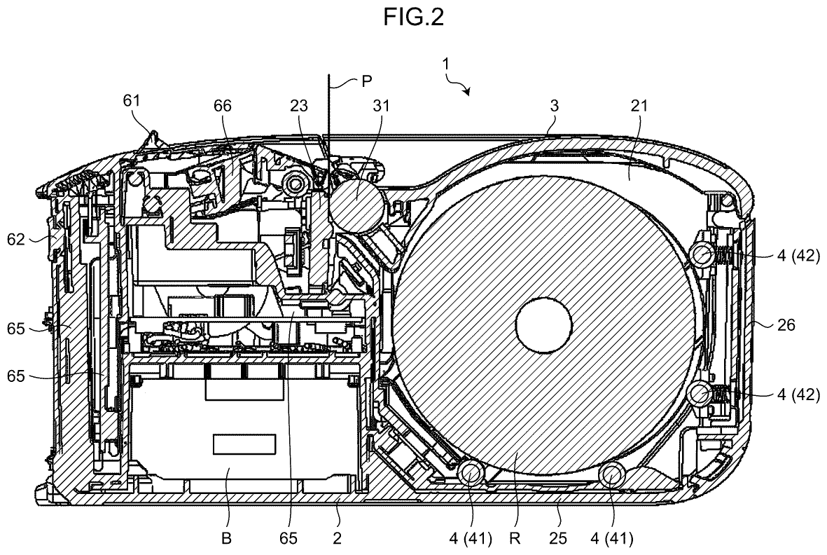

The power supply unit work to drive the respective elements based on the electric power supplied from a mounted battery B (see FIG. 2). Circuits and a processor are mounted on a circuit board 65 (see FIG. 2) for controlling the printer 1. A control unit includes the processor mounted on the circuit board 65 and controls the printer 1 to feed paper sheets and print on the paper sheets or perform operations in response to button operations. The printing unit performs printing on the paper sheets when fed. The printing unit includes, for example, a print head 23 (a thermal head) that performs printing by applying heat to the paper sheets. The print head 23 prints information on a fed paper sheet P (see FIG. 2).

The printer 1 includes, in the rear part, the cover 3 pivotably attached to the printer body 2. The cover 3 pivots with respect to the printer body 2 to open and close the inside of the printer 1. With the cover 3 opened with respect to the printer body 2, the storage unit 21 is open to allow a roll paper R (see FIG. 2) to be set in the storage unit 21. With the cover 3 closed with respect to the printer body 2, the roll paper R is contained in the storage unit 21.

The cover 3 has a platen 31 attached thereto in a rotatable manner. The platen 31 represents an example of a feeding unit that draws out and feeds a paper sheet from the outermost periphery of the roll paper stored in the storage unit 21. The platen 31 is made of a cylindrical rubber material. With the cover 3 closed with respect to the printer body 2, the platen 31 is placed opposite to the print head 23, allowing the outer periphery of the platen 31 to be pressed by the print head 23. The rotation of the platen 31 in this state feeds the paper sheet P held between the platen 31 and the print head 23. That is, the platen 31 draws out the paper sheet P from the outermost periphery of the roll paper R and delivers the paper sheet P to the printing unit.

The printer 1 includes an open-close button 61 on the top face of the printer body 2. Using the open-close button 61, the cover 3 can be released from the closed state with respect to the printer body 2 and opened. After the release of the cover 3, the user lifts and rotates the cover 3 with his or her hand to open the inside of the printer 1 including the storage unit 21 in the upward direction.

The printer 1 includes an operational unit 62 with a power button. The power button is used to switch on and off the power supply of the printer 1. The operational unit 62 is connected to the circuit board 65. In response to receipt of a button operation, the circuit board 65 implements the operation corresponding to the button operation.

The printer 1 also includes elastomers 63 at the four corners of the printer body 2. The elastomers 63 are, for example, rubber-like elastic members that absorb and mitigate the impact on the printer 1 arising from falling of the printer 1 on the floor, a desk, the ground, or etc., if it occurs.

The printer 1 includes two pairs of supporting units 4 in the storage unit 21. The supporting units 4 represent a mechanism for rotatably supporting the roll paper stored in the storage unit 21. The supporting units 4 work to cushion a drop impact from the roll paper when the printer 1 is dropped. A pair (two) of supporting units 4 are disposed on each of two inner faces of the printer body 2 or the storage unit 21. The supporting units 4 will be described below in detail with reference to FIG. 2.

The printer body 2 further includes the elastomers 63 at the four corners. The elastomers 63 function as dampers made of, for example, a rubber-like elastic material that is deformed to mitigate the impact on the printer 1 arising from the falling of the printer 1.

The printer body 2 is provided with a cover 64 on a lateral side for attaching and detaching a battery that supplies electric power to the power supply unit. To attach or detach the battery to or from the printer 1, the cover 64 is opened.

An internal structure of the printer 1 is now explained. FIG. 2 is a side cross-sectional view illustrating an internal configuration of the printer 1 being in the transverse-placed state. FIG. 2 illustrates a state of the printer 1 with the cover 3 closed with respect to the printer body 2. The front side of the printer 1 is shown on the left side of FIG. 2. As illustrated in FIG. 2, the printer 1 includes, on the right side (i.e., on the back side of the printer 1), the storage unit 21 for storing the roll paper R; the print head 23 and the platen 31 located above substantially the central part of the printer 1; the battery B located in the lower front side of the printer 1; the circuit board 65 and the operational unit 62 located at the front side; and a detachment mechanism 66 located at the upper front side.

With reference to FIG. 2, two pairs of supporting units 4 are disposed at two different locations in the lower part of the storage unit 21. One of the two pairs of supporting units 4 (supporting units 41) is provided at a first location. Specifically, the pair of supporting units 4 (supporting units 41) is provided on the inner face of a bottom 25 of the printer body 2, the bottom 25 being the lower part of the storage unit 21. In the transverse-placed state of the printer 1, the supporting units 41 support the roll paper R from below.

FIG. 2 illustrates a state of the storage unit 21 containing the roll paper R. The pair of supporting units 41 support, at two points, the outer periphery of the roll paper R stored in the storage unit 21, from the direction of gravity of the roll paper R (i.e., supports the roll paper R from below). Although explained later in detail, each supporting unit 41 includes rollers 413 that support the roll paper R by contacting the roll paper R at two points. The rotation of the rollers 413 can smoothly rotate the roll paper R supported thereby.

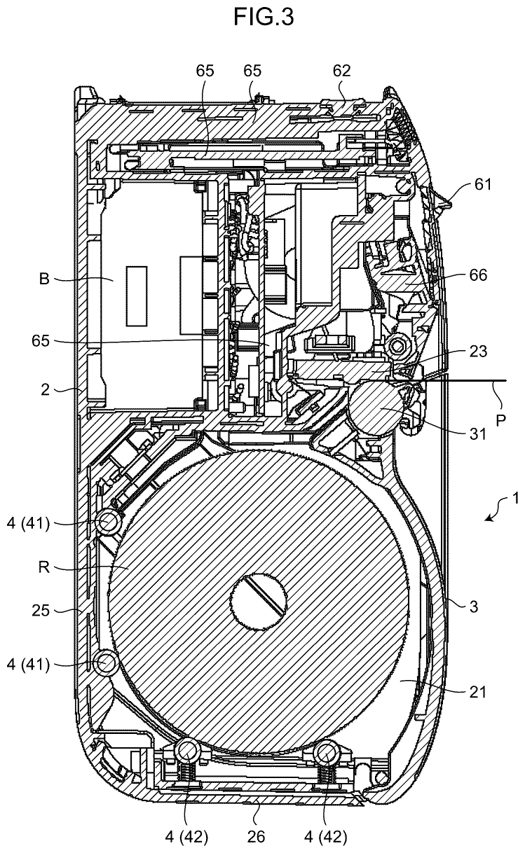

The other pair of supporting units 4 (supporting units 42) is provided at a second location which is on the inner face of a back side 26 of the printer 1 erected at an angle of about 90° from the bottom 25. The supporting units 42 will be explained later with reference to FIG. 3.

As illustrated in FIG. 2, with the cover 3 closed with respect to the printer body 2, the print head 23 and the platen 31 are located opposite to each other, and the platen 31 is pressed by the print head 23. At the time of closing the cover 3, the paper sheet P is set by drawing out the paper sheet P from the outer periphery of the roll paper R stored in the storage unit 21, and holding that in-between the print head 23 and the platen 31. By rotating the platen 31 in this state, the paper sheet P is discharged (issued) to the outside of the printer 1. By driving the print head 23 while rotating the platen 31, the paper sheet P on which characters or graphic symbols are printed is discharged to the outside of the printer 1.

With reference to FIG. 2, the detachment mechanism 66 is disposed on the left side of the print head 23. FIG. 2 illustrates that the detachment mechanism 66 is located at a retracted position. For the roll paper R having labels attached thereto, the detachment mechanism 66 is moved from the retracted position illustrated in FIG. 2 to a detachment position (not illustrated), to detach printed labels from the paper mount for output.

Below the detachment mechanism 66, the printer 1 includes the power supply unit which drives the printer 1, and a compartment for housing the battery B which supplies electric power to the power supply unit.

The circuit board 65 is disposed in-between the detachment mechanism 66 and the power supply unit and on the front side of the printer 1. A processor, a ROM, and a RAM are mounted on the circuit board 65 to operate the printer 1 supplied with electric power from the power supply unit.

FIG. 3 is a side cross-sectional view illustrating an internal configuration of the printer 1 being in the upright state. In FIG. 2, the printer 1 is installed such that the bottom 25 serves as the bottom. In the upright state of the printer 1 illustrated in FIG. 3, the back side 26 serves as the bottom. The internal configuration of the printer 1 illustrated in FIG. 3 is identical to the internal configuration illustrated in FIG. 2, therefore, an explanation thereof is omitted.

With reference to FIG. 3, the pair of supporting units 42 supports the outer periphery of the roll paper R stored in the storage unit 21, from the direction of gravity of the roll paper R (i.e., supports the roll paper R from below). Although explained later in detail, each supporting unit 42 includes a roller 423 (see FIG. 5) that supports the roll paper R by contacting the roll paper R at two points. The rotation of the rollers 423 can smoothly rotate the roll paper R.

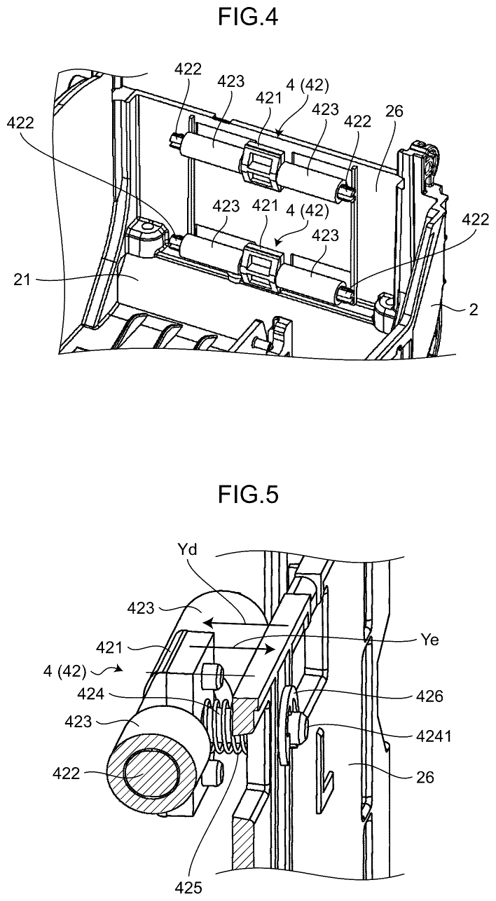

The supporting units 4 are now described. Herein, the supporting units 42 are explained on behalf of the supporting units 4, referring to FIG. 4. The supporting units 41 and the supporting units 42 have the same configuration.

FIG. 4 is an explanatory diagram illustrating a configuration of the supporting units 42 attached to the printer 1. As illustrated in FIG. 4, the pair of supporting units 42 is attached to the inner face of the back side 26 in a substantially parallel manner. Each supporting unit 42 includes a base 421, spindles 422, and the rollers 423. Although explained later in detail with reference to FIG. 5, the base 421 is attached as a cushion to the inner face of the back side 26. As an example, the base 421 is elastically attached to the inner face of the back side 26. The spindles 422 are integrated with the base 421 and extend to both sides from the base 421. The base 421 and the spindles 422 are made of resin or plastic. The rollers 423 are hollow, cylindrical members that are pivotally supported by the respective spindles 422 in a rotatable manner. The rollers 423 are made of, for example, a resin, plastic, or rubber material.

The supporting units 42 are attached to the back side 26 in parallel to each other at intervals. The rollers 423 abut against the outer periphery of the roll paper R stored in the storage unit 21, to support the roll paper R in a rotatable manner.

FIG. 5 is an explanatory diagram illustrating a detailed configuration of the supporting unit 42. For better understanding of the configuration, FIG. 5 depicts a partial cross-section of the spindles 422 and the rollers 423. With reference to FIG. 5, the base 421 includes a cylindrical protrusion 424. A leading end 4241 of the protrusion 424 protrudes from the back side 26 in the opposite direction to the supporting unit 42. The leading end 4241 has a washer 426 fitted therein. A coil spring 425 is attached to the outer periphery of the protrusion 424. The coil spring 425 represents an example of a damper, an elastic member, and a spring.

In a compressed state, the coil spring 425 is in contact with the base 421 and the back side 26, biasing the base 421 in the direction away from the back side 26 (i.e., in an arrow Yd direction). Applied with a force in the opposite direction to the biasing direction of the coil spring 425 (i.e., in an arrow Ye direction), the base 421 can move in the opposite direction to the biasing direction of the coil spring 425 (i.e., in the arrow Ye direction) against the biasing force of the coil spring 425. Along with the movement of the base 421 in the arrow Ye direction, the spindles 422 and the rollers 423 also rotate in the arrow Ye direction. In other words, an applied force on the roller 423 in the arrow Ye direction causes the spindles 422 and the base 421 to move in the arrow Ye direction against the biasing force of the coil spring 425. Thus, the applied force on the rollers 423 in the arrow Ye direction from the roll paper R causes the supporting units 42 to move in the arrow Ye direction against the biasing force of the coil spring 425.

The supporting units 41 have the same configuration as the supporting units 42, so that a detailed explanation is omitted. However, each supporting unit 41 includes a base 411, spindles 412, rollers 413, a protrusion 414, a leading end 4141, a coil spring 415, and a washer 416 that correspond to the base 421, the spindles 422, the rollers 423, the protrusion 424, the leading end 4241, the coil spring 425, and the washer 426, respectively. The rollers 413 abut against the outer periphery of the roll paper R stored in the storage unit 21, to support the roll paper R.

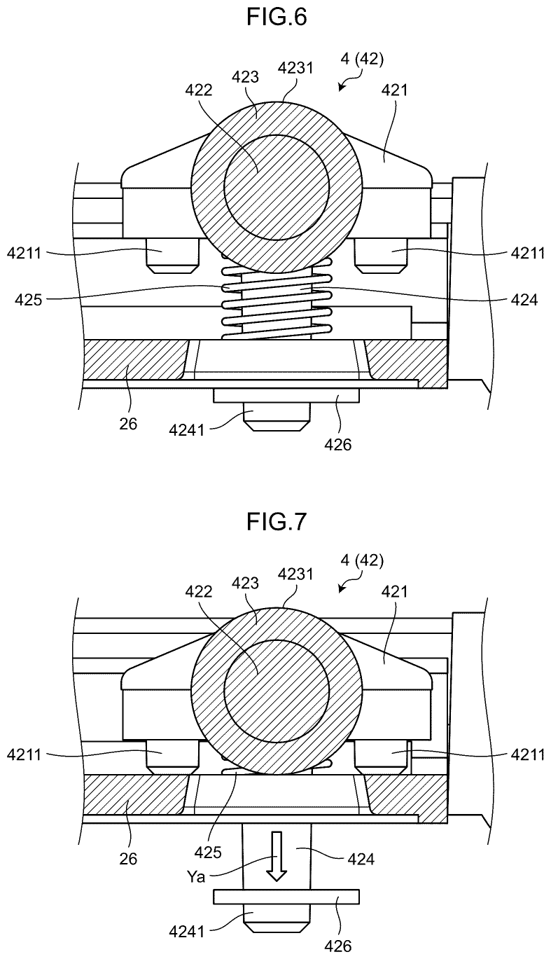

FIG. 6 is an enlarged view of a configuration of the supporting unit 42 in the printer 1 being in the upright state. On account of being biased by the coil spring 425, the supporting unit 42 (i.e., the base 421, the spindles 422, the rollers 423, and the protrusion 424) is held while floating upward from the back side 26. In this state, the washer 426 abuts against the outside of the back side 26, so that the supporting unit 42 is held while floating upward at a predetermined distance from the back side 26. Although not illustrated in FIG. 6, the roll paper R stored in the storage unit 21 is supported by the rollers 423 in abutment with an outer periphery 4231 of each roller 423.

Meanwhile, the coil spring 425 has predetermined elasticity. Thus, due to the biasing force of the coil spring 425, even the supporting units 42 supporting the unused roll paper R are held in the upward-floating state at the predetermined distance from the back side 26, and the predetermined distance is not generally shortened by the compression of the coil spring 425. The base 421 is provided with two stoppers 4211 facing the back side 26 and separated upward from the back side 26.

FIG. 7 illustrates that the printer 1 being in the upright state has fallen on the ground, for example. Due to the impact from the falling of the printer 1, the supporting units 42 (directly, the rollers 423) are subjected to a large downward (indicated by the arrow Ya) force from the roll paper R because of the self-weight of the roll paper R. When the downward force is greater than the self-weight of the roll paper R, the coil spring 425 becomes compressed (i.e., deformed) by the large downward force exerted on the supporting units 42. The compression of the coil spring 425 causes the supporting units 42 to move in the arrow Ya direction against the biasing force of the coil spring 425. As a result of moving in the arrow Ya direction, the supporting units 42 can absorb the impact from the roll paper R due to the falling of the printer 1. The maximum moving distance of the supporting units 42 is equal to the distance (a predetermined distance) that the stoppers 4211 abut against the back side 26. FIG. 7 depicts that the stoppers 4211 has abutted against the back side 26 and the supporting unit 42 has moved downward by the predetermined distance.

In this manner, the supporting units 42 according to an embodiment can absorb the impact from the roll paper R arising from the falling of the printer 1 being in the upright state, by moving along with the compression of the coil spring 425. As a result, it is possible to mitigate the impact exerted on the printer 1.

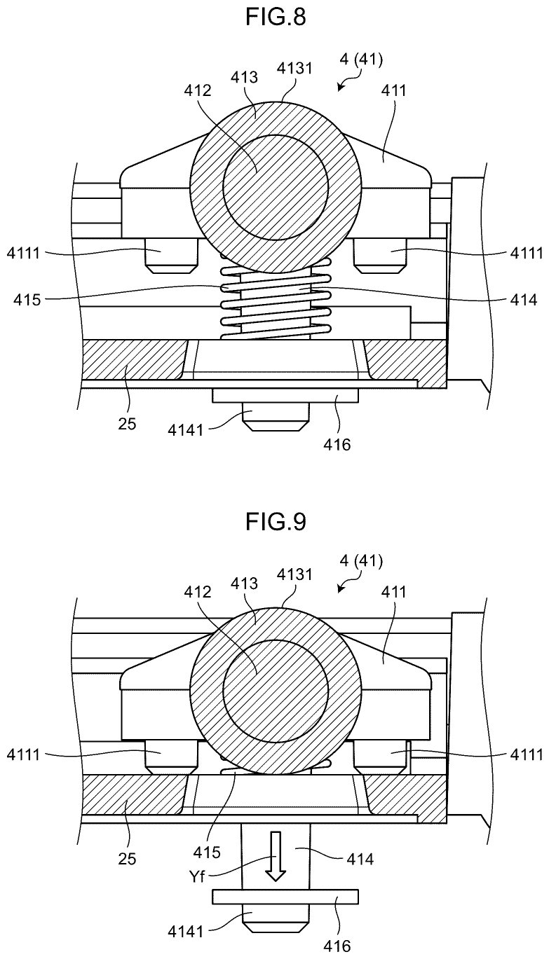

FIG. 8 is an enlarged view illustrating an configuration of the supporting unit 41 in the printer 1 being in the transverse-placed state. On account of being biased by the coil spring 415, the supporting unit 41 (i.e., the base 411, the spindles 412, the rollers 413, and the protrusion 414) is held in the upward-floating state from the bottom 25. The washer 416 abuts against the outside of the bottom 25 in this state, to be able to hold the supporting unit 41 in the upward-floating state by a predetermined distance from the bottom 25. Although not illustrated in FIG. 8, the roll paper R stored in the storage unit 21 is rotatably supported by the rollers 413 in contact with an outer periphery 4131 of each roller 413.

Meanwhile, the coil spring 415 has predetermined elasticity. Thus, even the supporting units 41 supporting the unused roll paper R can be held in the upward-floating state by the predetermined distance from the bottom 25 due to the biasing force of the coil spring 425, and the predetermined distance is not generally shortened by the compression of the coil spring 415. The base 411 is provided with two stoppers 4111 facing the bottom 25 and separated from the bottom 25 in the upward direction.

FIG. 9 illustrates a state of the printer 1 when having fallen on the ground in the transverse-placed state, for example. Due to the impact from the falling of the printer 1, the supporting units 41 (directly, the rollers 413) receive, from the roll paper R, a large downward (indicated by an arrow Yf) force from the roll paper R because of the self-weight of the roll paper R. When the downward force is greater than the self-weight of the roll paper R, the coil spring 415 becomes compressed (i.e., bends in the direction of compression) by the large downward force exerted on the supporting units 41. The compression of the coil spring 415 causes the supporting units 41 to move in the arrow Yf direction against the biasing force of the coil spring 415. As a result of moving in the arrow Yf direction, the supporting units 41 can absorb the impact from the roll paper R arising from the falling of the printer 1. The maximum moving distance of the supporting units 41 is equal to the distance that the stoppers 4111 abut against the bottom 25. FIG. 9 depicts that the supporting unit 41 has moved until the stoppers 4111 abut against the bottom 25.

In this manner, the supporting units 41 according to an embodiment can move by the compression of the coil spring 415 to be thereby able to absorb the impact exerted from the roll paper R due to the falling of the printer 1 being in the transverse-placed state. As a result, the supporting units 41 can mitigate the impact exerted on the printer 1.

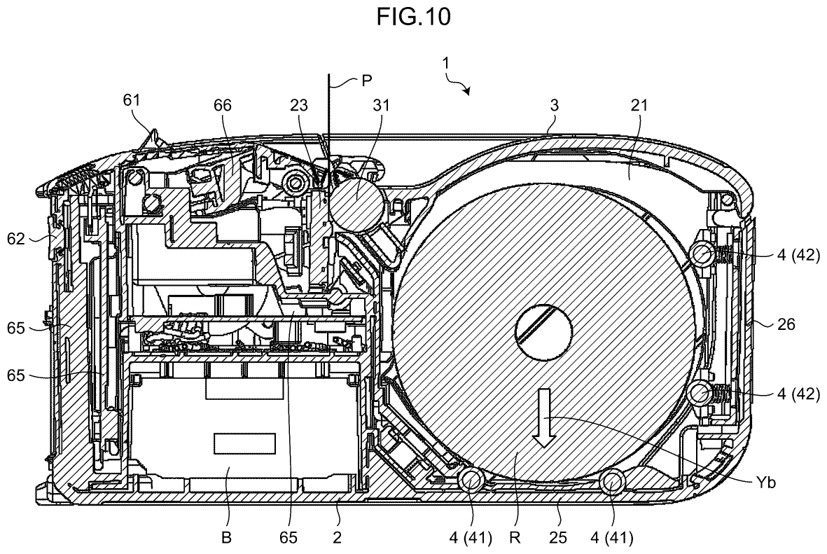

FIG. 10 is a side cross-sectional view illustrating the inside of the printer 1 that is subjected to an impact from the falling thereof in the transverse-placed state. As illustrated in FIG. 10, applied with a force in an arrow Yb direction from the roll paper R due to the falling of the printer 1, the supporting units 41 disposed in the printer 1 move further than the printer 1 illustrated in FIG. 2 in the arrow Yb direction. Thereby, the supporting units 41 can absorb the impact exerted from the roll paper R stored in the storage unit 21, at the time of the falling of the printer 1 on the floor, a desk, or the ground, to be thereby able to mitigate the impact exerted on the printer 1.

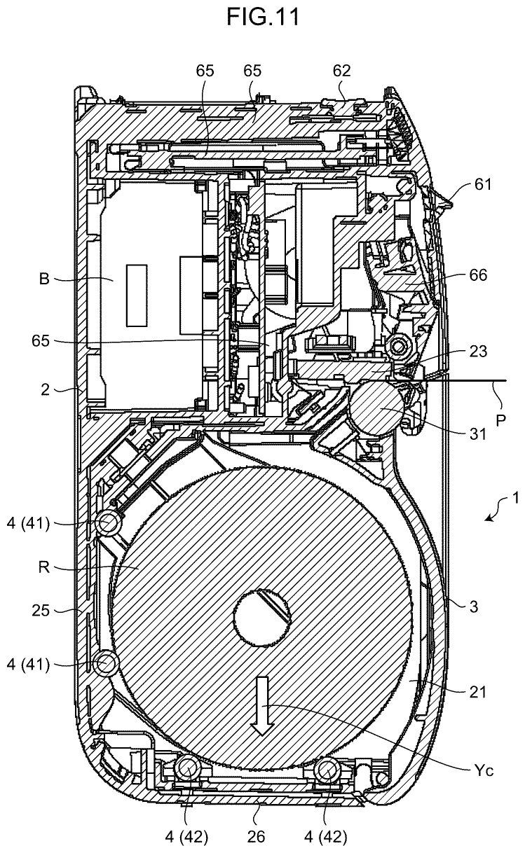

FIG. 11 is a side cross-sectional view of the inside of the printer 1 when is subjected to an impact from the falling thereof in the upright state. As illustrated in FIG. 11, applied with a force in an arrow Yc direction from the roll paper R due to the falling of the printer 1, the supporting units 42 disposed in the printer 1 move further than the printer 1 illustrated in FIG. 3 in the arrow Yc direction. As a result, the supporting units 42 can absorb the impact exerted from the roll paper R stored in the storage unit 21, at the time of the falling of the printer 1 on the floor, a desk, or the ground, to be thereby able to mitigate the impact exerted on the printer 1.

Modifications of embodiments are now described. The embodiments have described an example of absorbing the impact from the roll paper R due to the falling of the printer 1 on the floor or a desk to mitigate the impact exerted on the printer 1, by the supporting units 41's moving along with the compression of the coil springs 415 disposed therein and the supporting units 42's moving along with the compression of the coil springs 425 disposed therein. According to a modification, each supporting unit includes elastic pieces integrated with the base 411 and the base 421 in place of the coil springs 415 and the coil springs 425. The supporting units 41 and 42 of a modification have the same configuration as the supporting units 41 and 42 according to some embodiments, except for the elastic pieces. However, the coil springs 415 and 425 are not included therein.

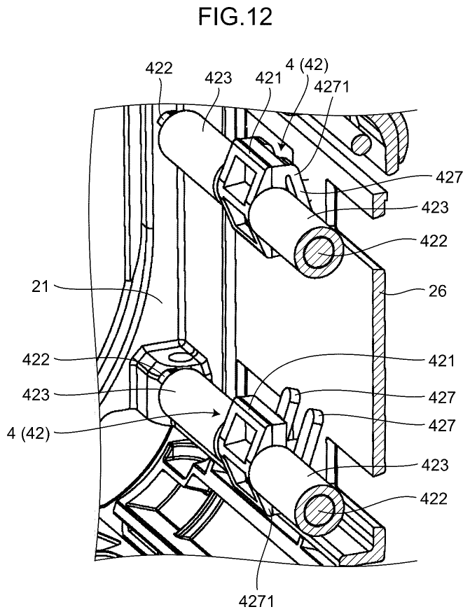

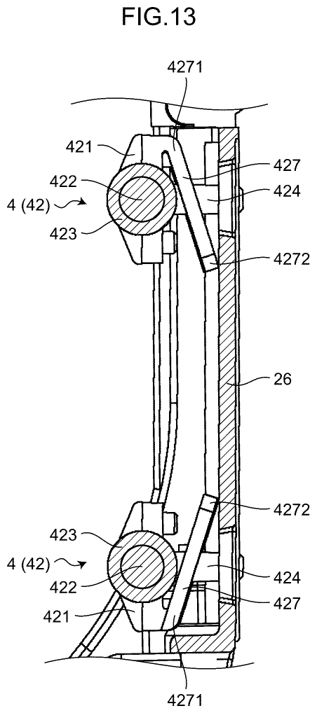

Modifications will be described below with reference to FIGS. 12 and 13, using the supporting units 42 attached to the back side 26. The supporting units 42 and the supporting units 41 both attached to the bottom 25 have the same configuration. In the following description of modifications, the same or similar elements as some embodiments are denoted by the same reference numerals, and an explanation thereof is simplified or omitted.

FIG. 12 is an explanatory diagram illustrating a state of the supporting units 42 attached to the back side 26 according to a modification. As illustrated in FIG. 12, each base 421 includes elastic pieces 427. The bases 421 and the elastic piece 427 are integrated together through a connecting member 4271. Thus, the base 421 includes the connecting member 4271 and the elastic pieces 427 in an integrated manner. The elastic pieces 427 represent, for example, two rod-like members. The connecting member 4271 and the elastic pieces 427 are an example of a damper, an elastic member, and a spring.

By the supporting units 42 according to such a modification attached to the back side 26, a leading end 4272 of each elastic piece 427 opposite to the connecting member 4271 (see FIG. 13) abuts against the inner face of the back side 26. The bases 421, the connecting members 4271, and the elastic pieces 427 are made of, for example, resin or plastic. Hence, applied with a force, the elastic pieces 427 generates an elastic force by elastic deformation of the connecting members 4271 because of their leading ends 4272 in abutment with the back side 26. Thereby, the supporting units 42 are elastically movable toward the back side 26. That is, by the elastic force of the elastic pieces 427 caused by the deformation of the connecting members 4271, the supporting units 42 according to this modification can perform the same or similar function as the supporting units 42 incorporating the coil springs 425 according to some embodiments.

FIG. 13 is a side view of the configuration of the supporting units 42 attached to the back side 26 according to a modification, when viewed from a lateral side. As illustrated in FIG. 13, the leading ends 4272 are in abutment with the inner face of the back side 26 while the supporting units 42 are attached to the back side 26. In this state, the protrusions 424 protrude to the outer face of the back side 26 and are attached to the back side 26 using the washers 426 (not illustrated). Thus, the supporting units 42 are biased by the elastic pieces 427 toward the opposite side of the back side 26 (i.e., leftward in FIG. 13), as in some embodiments.

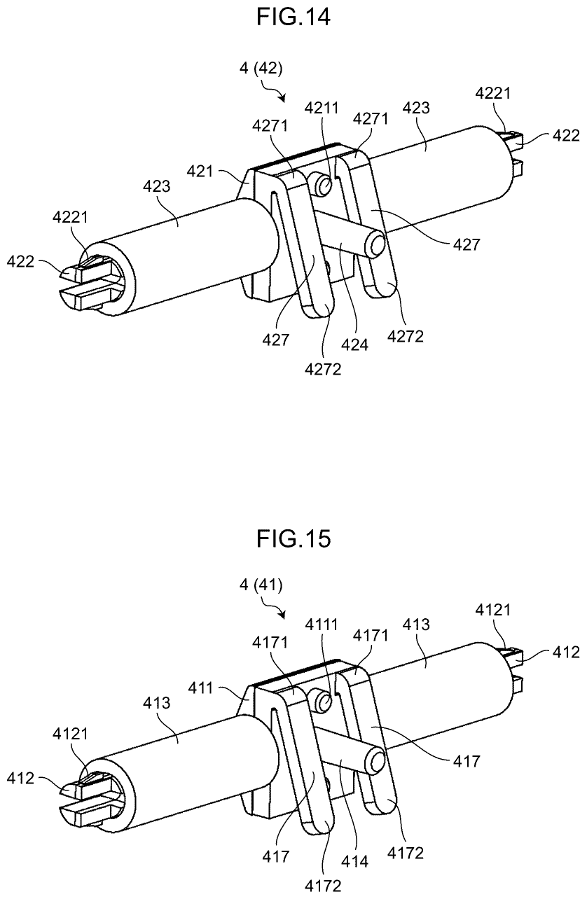

FIG. 14 is an explanatory diagram illustrating a configuration of the supporting unit 42 according to a modification. In FIG. 14, the supporting unit 42 includes the spindles 422 extending on both sides of the base 421. Each spindle 422 has the roller 423 fitted therein in a rotatable manner. The leading end of each spindle 422 is provided with a latching hook 4221 to ensure that the roller 423 fitted in the spindle 422 is prevented from coming off. The leading end of the spindle 422 in some embodiments is also provided with the latching hook 4221.

Each base 421 integrally includes the elastic pieces 427 via the connecting member 4271. By the deformation of the connecting member 4271, the elastic pieces 427 elastically support the base 421 (i.e., the supporting unit 42). Each base 421 also includes the protrusion 424 and the two stoppers 4211.

The supporting units 41 according to a modification and the supporting units 42 according to another modification have same or similar configuration. Specifically, the elements of each supporting unit 42 include the base 421, the stoppers 4211, the spindles 422, the latching hooks 4221, the rollers 423, the protrusions 424, the elastic pieces 427, the connecting members 4271, and the leading ends 4272 that correspond to the elements of each supporting unit 41 including the base 411, the stoppers 4111, the spindles 412, latching hooks 4121, the rollers 413, the protrusions 414, elastic pieces 417, connecting members 4171, and leading ends 4172, respectively.

FIG. 15 is an explanatory diagram illustrating the configuration of the supporting unit 41 according to this modification. In FIG. 15, the supporting unit 41 includes the spindles 412 extending on both sides of the base 421. Each spindle 412 has the roller 413 fitted therein in a rotatable manner. The leading end of each spindle 412 is provided with the latching hook 4121 to ensure that the roller 413 fitted in the spindle 412 is prevented from coming off.

Each base 411 integrally includes the elastic pieces 417 via the connecting member 4171. By the deformation of the connecting member 4171, the elastic pieces 417 elastically support the base 411 (i.e., the supporting unit 41). Each base 411 also includes the protrusion 414 and the two stoppers 4111.

According to such a modification, when the printer 1 being in the upright state falls, the supporting units 42 are subjected to a force from the self-weight of the roll paper R. However, the supporting units 42 can elastically move toward the back side 26 against the biasing force owing to the elastic deformation of the connecting members 4271. In this manner, as a result of the elastic movement of the supporting units 42, it is possible to absorb the force attributed to the self-weight of the roll paper R at the time of the falling of the printer 1, and mitigate the impact on the printer 1 arising from the falling.

When the printer 1 being in the transverse-placed state according to such a modification falls, the supporting units 41 are subjected to a force attributed to the self-weight of the roll paper R. However, the supporting units 41 can elastically move toward the bottom 25 against the biasing force owing to the elastic deformation of the connecting members 4171. In this manner, as a result of the elastic movement of the supporting units 41, it is possible to absorb the force attributed to the self-weight of the roll paper R at the time of the falling of the printer 1, thereby mitigating the impact on the printer 1 arising from the falling.

As explained above, the printer 1 according to an embodiment includes the storage unit 21 that stores the roll paper R; the platen 31 that draws out and feeds a paper sheet from the outer periphery of the stored roll paper R; the print head 23 that performs printing on the fed paper sheet; and the supporting units 4 disposed in the storage unit 21, to rotatably support the stored roll paper R and mitigate the drop impact from the roll paper R.

The printer 1 according to such an embodiment is able to mitigate the drop impact exerted from the roll paper R held inside, at the time of the falling.

Moreover, the printer 1 according to an embodiment includes dampers that mitigate the drop impact exerted from the roll paper R held inside, at the time of the falling.

The printer 1 according to such an embodiment is able to use the dampers to mitigate the drop impact exerted from the roll paper R held inside, at the time of the falling.

Further, in the printer 1 according to such an embodiment, the dampers are elastic members that are deformable to elastically support the roll paper R.

Thus, by the deformation of the elastic members, the printer 1 according to such an embodiment can mitigate the drop impact exerted from the roll paper R held inside, at the time of the falling.

The printer 1 according to an embodiment includes the pair of rollers 413 and the pair of rollers 423 that rotatably support the roll paper R in abutment with the outer periphery of the roll paper R. The elastic members elastically support the rollers 413 and 423.

By elastically supporting the rollers 413 and 423, the printer 1 according to such an embodiment is able to mitigate the drop impact exerted from the roll paper R held inside, at the time of the falling.

For example, according to some embodiments, the elastic members are used as dampers as an example. However, this is not to be construed as limiting. Thus, the dampers can be other members different from the elastic members. For example, the dampers can be magnets. As an example, one of two repelling magnets may be attached to the base 421 while the other magnet may be attached to the printer body 2 to oppose the former magnet. Thereby, the supporting units 4 remain separated at a predetermined interval from the printer body 2 by the repulsive force of the magnets. When the supporting units 4 are subjected to a force greater than the self-weight of the roll paper R because of the falling of the printer 1, the distance between the two magnets can be decreased against the repulsive force, to thereby absorb the impact exerted from the roll paper R and mitigate the impact exerted on the printer 1.

In contrast, two attracting magnets can be used. When the supporting units 4 are subjected to a force greater than the self-weight of the roll paper R because of the falling of the printer 1, the distance between the two attracting magnets may be increased using the force to separate the two attracting magnets to thereby absorb the impact exerted from the roll paper R and mitigate the impact exerted on the printer 1.

In some embodiments, the supporting units 4 are attached to two different locations, i.e., the supporting units 41 attached to the bottom 25 and the supporting units 42 attached to the back side 26. However, this is not to be construed as limiting. The supporting units 4 may be attached to one or more locations.

In some embodiments, the rollers 413 and 423 are elastically supported by elastic members. However, this is not to be construed as limiting. Alternatively, the rollers 413 and 423 themselves can be made of an elastic material (for example, rubber). In this case, the rollers 413 and 423 can deform to absorb the force exerted from the roll paper R arising from the falling of the printer 1 to thereby mitigate the impact exerted on the printer 1.

As used herein, the singular forms “a”, “an” and “the” are intended to include the plural forms as well, unless the context clearly indicates otherwise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a storage unit configured to store a roll paper;
a feeding unit configured to draw out and feed a paper sheet from an outer periphery of the stored roll paper;
a printing unit configured to perform printing on the fed paper sheet; and
a supporting unit disposed in the storage unit, and configured to rotatably support the stored roll paper and mitigate a drop impact from the roll paper.

2. The printer according to claim 1, wherein
the supporting unit includes a damper that mitigates the drop impact from the supported roll paper at a time when the printer falls.

3. The printer according to claim 2, wherein
the damper is an elastic member that elastically supports the roll paper.

4. The printer according to claim 3, wherein
the supporting unit includes a pair of rollers that abut against the outer periphery of the roll paper and rotatably support the roll paper, and
the elastic member is deformable to elastically support the rollers.

5. The printer according to claim 4, wherein
the supporting unit includes a base and a spindle that rotatably supports the pair of rollers, the pair of rollers being integrated with the base, and
the elastic member is attached to the base to elastically support the pair of rollers.

6. The printer according to claim 5, wherein,
the elastic member is deformed to mitigate the drop impact from the roll paper at a time when the printer falls.

7. The printer according to claim 6, wherein
the elastic member is a deformable coil spring.

8. The printer according to claim 7, wherein
the coil spring is attached to a protrusion formed on the base.

9. The printer according to claim 6, wherein
the elastic member is an elastic piece integrally attached to the base.

10. The printer according to claim 9, wherein
the elastic piece includes a deformable connecting piece connected to the base.

11. The printer according to claim 2, wherein
the supporting unit is disposed on each of two different faces of the storage unit.

12. The printer according to claim 11, wherein
the supporting unit includes a pair of supporting units disposed on each face of the storage unit.

13. The printer according to claim 3,
the supporting unit is disposed on each of two different faces of the storage unit.

14. The printer according to claim 13, wherein
the supporting unit includes a pair of supporting units disposed on each face of the storage unit.

15. The printer according to claim 4, wherein
the supporting unit is disposed on each of two different faces of the storage unit.

16. The printer according to claim 15, wherein
the supporting unit includes a pair of supporting units disposed on each face of the storage unit.

17. The printer according to claim 3, wherein
the damper includes repulsive magnets or attracting magnets.

18. The printer according to claim 11, wherein
in a transverse-placed state of the printer, the supporting unit disposed on one of the two faces supports the roll paper, and
in an upright state of the printer, the supporting unit disposed on the other of the two faces supports the roll paper.

19. The printer according to claim 13, wherein
in a transverse-placed state of the printer, the supporting unit disposed on one of the two faces supports the roll paper, and
in an upright state of the printer, the supporting unit disposed on the other of the two faces supports the roll paper.

20. The printer according to claim 15, wherein
in a transverse-placed state of the printer, the supporting unit disposed on one of the two faces supports the roll paper, and
in an upright state of the printer, the supporting unit disposed on the other of the two faces supports the roll paper.
